(19) United States
(12) Patent Application Publication
(10) Pub. No.: US 2026/0318687 A1
(43) Pub. Date: Oct. 15, 2026

(54) METHOD AND DEVICE FOR POSITIONAL TRACKING

(71) Applicant: PITPATPET LTD, Cambridge (GB)

(72) Inventors: Matthew STORKEY, Cambridge (GB); Andrew NOWELL, Cambridge (GB); Jake APSEY, Cambridge (GB)

(73) Assignee: PITPATPET LTD, Cambridge (GB)

(21) Appl. No.: 18/998,673

(22) PCT Filed: Jul. 26, 2023
(86) PCT No.: PCT/IB2023/057571

§ 371 Date: Jan. 27, 2025

(30) Foreign Application Priority Data
Jul. 26, 2022 (GB) 2210905.2

(51) Int. Cl. G01C 21/16; G01S 19/39; G01S 19/49; G01S 19/51

(52) U.S. Cl. CPC G01C 21/165; G01S 19/396; G01S 19/49; G01S 19/51

(57) ABSTRACT

A method for positional tracking of a device. The method includes obtaining first absolute position of device at first location; determining path traveled by device between first location and second location, based on intermediate absolute position(s) of device that is received while device is traveling between first location and second location; determining relative position(s) of the device along path between first location and second location, wherein given relative position of given intermediate absolute position is determined by forward tracking of given intermediate absolute position with respect to first location, and backward tracking of given intermediate absolute position with respect to second location; calculating error in determining relative position(s) of device; and obtaining second absolute position of device at second location when error in determining relative position(s) of device exceeds predefined threshold.

### TECHNICAL FIELD

The present disclosure relates generally to geo-location tracking of an object and more specifically, to a method and a device for positional tracking over time with a combination of absolute position sensor(s) and relative position sensor(s) while minimizing battery consumption.

### BACKGROUND

Positional tracking refers to recording of displacements of an object in an environment over a time, and may be used for a number of purposes such as: traffic checking, surveillance, security, and the like. Typically, absolute position sensors like global positioning systems (GPS) are used for positional tracking because of their accuracy. For this purpose, typically, a portable tracking device is associated with the object to be tracked. The device receives and decodes GPS signals that are broadcast by GPS satellites. Other absolute position sources are additionally or alternatively employed to obtain location information using signals from mobile-phone cell-towers, Wi-Fi signals, and other radio transmission signals.

Electronic devices implementing absolute position sensors have high power consumption to receive and decode such signals, which is a problem for a portable unit which relies on batteries for its power. This is particularly a challenge for wearable devices worn by a human or an animal because such devices are usually size constrained, resulting in a limit on the energy capacity of the battery. Operational time of such devices is therefore dependent on minimizing the power consumption of the device and in particular the power consumed to perform location measurement (positional tracking).

One existing technique for improving the power consumption is to use information about change in position by continuously or rapidly measuring acceleration, using relative position sensors. Three axis accelerometer, magnetometer and gyroscopes are available as integrated circuits. These relative position sensors use micro-mechanical circuits to perform measurements at very low power levels but are not as accurate as absolute position sensors. US2007204804A1 describes a process for periodically sampling GPS signals while using an accelerometer to track position between measurements. This approach leads to lower overall power consumption than using just GPS measurement but affects location accuracy. CN106680856A describes adjusting timing of the GPS measurement based on accumulated error from a previous GPS measurement, however as this approach needs to report real time location, no benefit on a knowledge of location can be derived from any future GPS measurement that are made.

Therefore, in light of the foregoing discussion, there exists a need to overcome the aforementioned drawbacks associated with the conventional methods of positional tracking.

### SUMMARY

The present disclosure seeks to provide a method and a device for positional tracking. The present disclosure seeks to provide a solution to the existing problem of higher power consumption of devices for positional tracking. An aim of the present disclosure is to provide a solution that overcomes at least partially the problems encountered in the prior art, and provides an improved method and device for positional tracking that has lower power consumption.

In one aspect, the present disclosure provides a method for positional tracking of a device, comprising:
obtaining a first absolute position of the device at a first location;
determining a path traveled by the device between the first location and a second location, based on at least one intermediate absolute position of the device that is received while the device is traveling between the first location and the second location;
determining at least one relative position of the device along the path between the first location and the second location, wherein a given relative position of a given intermediate absolute position is determined by forward tracking of the given intermediate absolute position with respect to the first location, and backward tracking of the given intermediate absolute position with respect to the second location;
calculating an error in determining the at least one relative position of the device; and
obtaining a second absolute position of the device at the second location, when the error in determining the at least one relative position of the device exceeds a predefined threshold.

In another aspect, the present disclosure provides a device for positional tracking, comprising:
a first sensor configured to determine a first absolute position of the device at a first location, when activated;
a second sensor configured to determine at least one relative position of the device between the first location and a second location;
a battery for supplying power to at least the first sensor;
a processor configured to:
   receive information about the first absolute position of the device as determined by the first sensor;
   determine a path traveled by the device between the first location and the second location, based on at least one intermediate absolute position of the device that is received while the device is traveling between the first location and the second location;
   receive information about the at least one relative position of the device along the path between the first location and the second location as determined by the second sensor, wherein a given relative position of a given intermediate absolute position is determined by forward tracking of the given intermediate absolute position with respect to the first location, and backward tracking of the given intermediate absolute position with respect to the second location;
   calculate an error in determining the at least one relative position of the device; and
   activate the first sensor to obtain a second absolute position of the device at the second location when the error in determining the at least one relative position of the device exceeds a predefined threshold.

The method and the device of the present disclosure provide positional tracking by combining information gained from an absolute position (determined by a first sensor) and a relative position (determined by a second sensor) for a path traveled. The determined absolute position and a calculated error in the relative position along the path are used to determine when there is a need to determine a next absolute position, thus postponing activation of the first sensor for determining the next absolute position as much as possible while maintaining a chosen accuracy, and thereby minimizing power consumption.

It may be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart of a method for positional tracking of a device, in accordance with an embodiment of the present disclosure;

FIG. 2 is a diagrammatic illustration of a device for positional tracking, in accordance with an embodiment of the present disclosure;

FIG. 3 is a flowchart of a process flow involved in positional tracking of the device in FIG. 2, in accordance with an embodiment of the present disclosure

FIG. 4A is a representative illustration of a geographical area with a path followed by the device if the at least one intermediate absolute position is determined at regular intervals, in accordance with an embodiment of the present disclosure;

FIG. 4B is a representative illustration of the geographical area of FIG. 1 showing a contribution of the error of certainty of a given relative position with time when forward tracking of a given intermediate absolute position from a first location, in accordance with an embodiment of the present disclosure;

FIG. 4C is a representative illustration of the geographical area of FIG. 1 showing a contribution of the error of certainty of a given relative position with time when backward tracking of the given intermediate absolute position from the second location, in accordance with an embodiment of the present disclosure; and

FIG. 4D is a representative illustration of the geographical area of FIG. 1 showing a contribution of the error of certainty of a given relative position with time when both forward tracking of the given intermediate absolute position from the first location and backward tracking of the given intermediate absolute position from the second location, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is not underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

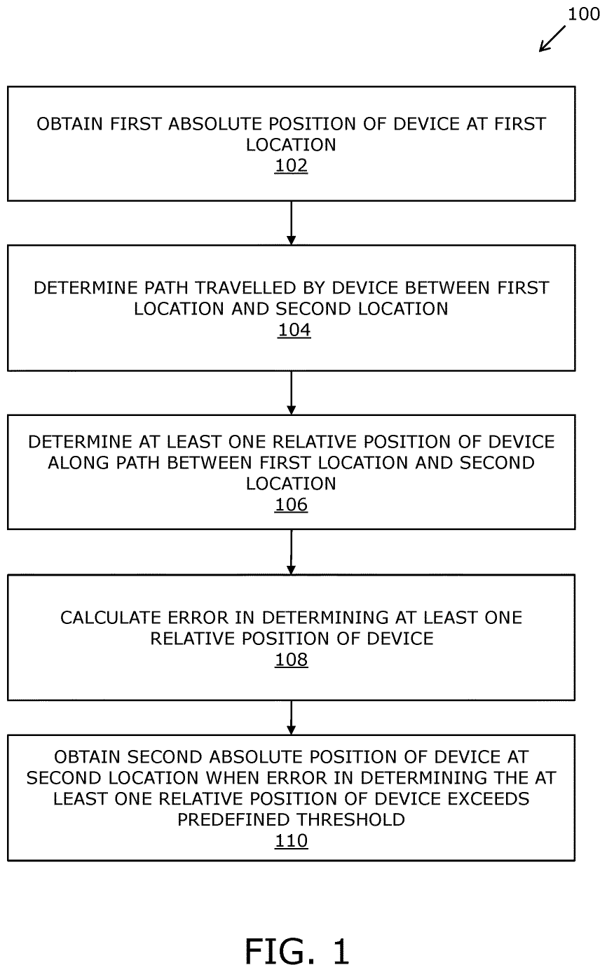

FIG. 1 is a flowchart of a method for positional tracking of a device, in accordance with an embodiment of the present disclosure. With reference to FIG. 1, there is shown a method, 100, for positional tracking of a device. The method 100 includes steps 102 to 110, which have been described in detail in the proceeding paragraphs.

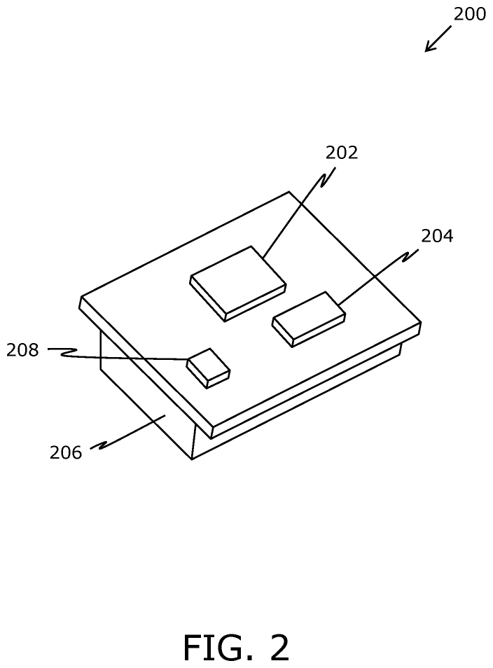

FIG. 2 is a diagrammatic illustration of a device 200 for positional tracking, in accordance with an embodiment of the present disclosure. It may be appreciated that the illustrated device 200 is exemplary only, and the shape, size and configuration/arrangement of elements therein may vary without departing from the spirit and the scope of the present disclosure. As shown in FIG. 2, the device 200 comprises a first sensor 202, a second sensor 204, a battery 206, and a processor 208.

Herein, the battery 206 is any energy storage device that provides electrical power for the device 200. In an embodiment, the battery 206 may be rechargeable. The processor 208 may be a central processing unit of a computing device configured to perform steps of the method 100 for positional tracking.

Throughout the present disclosure, the term “processor” refers to hardware, software, firmware, or a combination thereof. Optionally, the processor 208 includes any arrangement of physical or virtual computational entities capable of enhancing information to perform various computational tasks. Further, it will be appreciated that the processor 208 may be implemented as a hardware processor and/or plurality of hardware processors operating in a parallel or in a distributed architecture. Optionally, the processors in the processor 208 are supplemented with additional computation systems, such as neural networks, and hierarchical clusters of pseudo-analog variable state machines implementing artificial intelligence algorithms.

In an example, the processor 208 may include components such as a memory, a processing module, a data communication interface, a network adapter and the like, to store, process and/or share information with other computing devices, such as the data source. Optionally, the processor 208 includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit, for example as aforementioned. Additionally, the processor 208 is arranged in various architectures for responding to and processing the instructions for creating training data for the graph neural network to the point-cloud data of the geographical region comprising electrical utility components installed therein.

It may be appreciated that the device 200 may be positioned on or may be carried by an object that needs to be tracked. For example, if the position of a user needs to be tracked, wherein the device is worn by the user, the device 200 may be in the form of a wrist band that may be worn by the user. The positional tracking may provide a given absolute position (namely, the first absolute position and/or the second absolute position) that may be quantified in terms of a geographic location and an angle. In practical terms the geographic location can be described in terms of three axes ‘X’, ‘Y’ and ‘Z’, where ‘X’ and ‘Y’ may correspond to a local longitude coordinate and a local latitude coordinate and ‘Z’ may correspond to an altitude or a height. The angle of the device may be described in angular coordinates: an azimuth angle (φ) and an elevation angle (θ).

Referring to FIG. 1, at step 102, the method 100 comprises obtaining a first absolute position of the device 200 at a first location. As referred herein, in general, the given absolute position may be an accurate position of the device 200 at a given location. The given absolute position may be in the form of latitude, longitude and altitude, or any other co-ordinate system. Thereby, the first absolute position of the device 200 refers to the accurate position of the device 200 at the first location. In the present implementation, optionally, the first sensor 202 (as shown in FIG. 2) is used to determine the first absolute position of the device 200. The first sensor 202 may be configured to determine the first absolute position of the device 200, when activated, which is described in detail below. The first sensor 202 is activated when power is supplied thereto by the battery 206. Herein, the processor 208 is configured to receive information about the first absolute position of the device as determined by the first sensor.

In an embodiment, the first sensor 202 may be based on a global navigation satellite system (GNSS) including one or more of Global Positioning System (GPS), Global Navigation Satellite System (GLONASS), Galileo, BeiDou, Quasi-Zenith Satellite System (QZSS), Indian Regional Navigation Satellite System (IRNSS), and similar. In this regard, the positional tracking of the device may be optionally implemented as an outdoor positional tracking. Herein, when the first sensor may be based on the GPS, the first sensor 202 may receive GPS signals from each satellite and may measure a distance thereof from each satellite by measuring an amount of time taken to receive respective GPS signals. Samples may be taken from the GPS signals and may be interpreted as reference geographic locations of the device 200. It will be appreciated that the determination of the first absolute position using the GNSS is most accurate as it can access signals from the GPS, the GLONASS, Galileo, BeiDou, the QZSS, the IRNSS, and similar. In an alternative embodiment, the first sensor 202 may be based on one or more of: a cell-tower based triangulation system, a Wi-Fi signals based triangulation system, a Bluetooth® sensor, a Bluetooth® low energy sensor. In this regard, the positional tracking of the device may be optionally implemented as an indoor positional tracking. The cell-tower based triangulation system may determine the first absolute position by measuring signal strength and/or time taken by a signal to make a round trip between cell towers and the first sensor 202. In order to determine the first absolute position using the Wi-Fi signals based triangulation system, the first sensor 202 may scan nearby Wi-Fi access points and depending on signal strengths received from the scanned Wi-Fi access points, the first absolute position may be determined. In order to determine the absolute position using the Bluetooth® sensor, the first sensor 202 may receive Bluetooth® signals broadcasted by other Bluetooth® devices (such as, Bluetooth® beacons) for determining the first absolute position of the first sensor 202.

It may be appreciated that the determination of the given absolute position using the first sensor 202 may require high power consumption from the battery 206. Hence, it may be desired that the device 200 of the present disclosure may determine the given absolute position using the first sensor 202 at a low frequency and/or a variable frequency.

Referring to FIG. 1, at step 104, the method 100 comprises determining a path traveled by the device 200 between the first location and a second location, based on at least one intermediate absolute position of the device that is received while the device 200 is traveling between the first location and the second location. Herein, the processor 208 is configured to determine a path traveled by the device 200 between the first location and the second location. The path may be determined using a given intermediate absolute position (namely, the at least one intermediate absolute position) of the device 200, wherein the given intermediate absolute position may be determined using a previously-known intermediate absolute position, a previously-known direction of traveling, a distance traveled from the previously-known intermediate absolute position, of the device 200. In this regard, the positional tracking may provide the intermediate absolute position that may be quantified in terms of an intermediate geographic location and an intermediate angle. Herein, the intermediate geographic location and the intermediate angle is described in a similar manner as the description of the geographic location and the angle of the device 200, respectively.

For the present purpose, optionally, the second sensor 204 may be an accelerometer, a magnetometer, a gyroscope, or the like. In an embodiment, when the second sensor 204 is implemented as the magnetometer, the intermediate angle of the device 200 may be measured using samples from the magnetometer by comparing the angle of the device 200 to that of the earth's magnetic field at current position thereof. When the second sensor 204 is implemented as the gyroscope, an intermediate angular velocity of the device 200 may be measured when the device travels between the first location and the second location. Herein, the gyroscope may give high-resolution data rapidly when the angle changes with time (i.e., the angular velocity). As the device 200 travels between the first location and the second location, a plurality of intermediate angular velocities of the device 200 may be obtained, and said plurality of intermediate angular velocities are integrated to obtain the at least one intermediate absolute positions of the device 200. Herein, the device 200 may maintain a record of the intermediate angle of the device 200 with more accuracy. The intermediate angle measured using the gyroscope may be within a frame of reference that may need to be converted into a real-world frame of reference. A slower outer control loop may feedback an error as measured by the magnetometer to convert dynamic angle measurements in the frame of reference into a real-world angle measurement. When the second sensor 204 is implemented as the accelerometer, the at least one intermediate absolute position is obtained by taking samples of acceleration of the device 200 from the accelerometer, and further processing said samples of the acceleration of the device 200. The accelerometer may measure an intermediate acceleration of the device 200 in the three axes, as mentioned previously. By using the real-world angle measurement calculated above, the device 200 may transform the intermediate acceleration measured in the frame of reference of the device 200 into the intermediate acceleration of the device 200 in global coordinates. By integrating the transformed acceleration once, an intermediate velocity of the device 200 is obtained and by integrating the intermediate velocity, the at least one intermediate absolute position of the device 200 is obtained. It may be noted that constants of the above integration may be bounded by the first absolute position as determined by the first sensor 202. As the first sensor 202 may require high power, the device 200 uses the second sensor 204 frequently to track the given relative position of the given intermediate absolute position with the accuracy that may be dependent on multiple factors. Thus, by continuously receiving and updating the at least one intermediate absolute position of the device, using the processor, the path travelled by the device 200 may be estimated by the processor 208 That is, the path may be estimated by joining the at least one intermediate absolute position determined while traversing the path.

Referring back to FIG. 1, at step 106, the method 100 comprises of determining at least one relative position of the device 200 along the path between the first location and the second location, wherein a given relative position of a given intermediate absolute position is determined by forward tracking of the given intermediate absolute position with respect to the first location, and backward tracking of the given intermediate absolute position with respect to the second location. Herein, the processor 208 is configured to receive information about at least one relative position of the device 200 along the path between the first location and the second location as determined by the second sensor 204. In an example, the given relative position of the device 200 may be determined for the given intermediate absolute position between the first location and the second location. Herein, the at least one relative position of the at least one intermediate absolute position is determined with respect to the first location (i.e., the forward tracking) or is determined with respect to the second location (i.e., the backward tracking). Herein, the first location acts as a reference location when the given relative position of the given intermediate absolute position is determined by the forward tracking. Alternatively, the second location acts as another reference location when the given relative position of the given intermediate absolute position is determined by the backward tracking. The given intermediate absolute position may be defined such that the given intermediate absolute position is about midway between the first location and the second location.

In the present implementation, optionally, the second sensor 204 (as shown in FIG. 2) is used to determine the at least one relative position of the device 200 along the path between the first location and the second location. Specifically, the second sensor 204 is used to determine the given relative position of the given intermediate absolute position with respect to the first location of the path travelled by the device 200. Alternatively, specifically, the second sensor 204 is used to determine the given relative position of the given intermediate absolute position with respect to the second location of the path travelled by the device 200.

In an instance, when the given relative position of the given intermediate absolute position is determined by the forward tracking of the given intermediate absolute position with respect to the first location, and the backward tracking of the given intermediate absolute position with respect to the second location, at least one of: a previously-known relative position of the previously-known intermediate absolute position, a previously-known direction of travelling, a distance travelled from the previously-known relative position, of the device 200 with respect to a given location (namely, the first location and/or the second location) is used. A technical effect of determining the at least one relative position of the device in such a manner is that fewer measurements of the at least one intermediate absolute position is required to achieve an accuracy which is similar to an accuracy provided by conventional techniques. In this regard, the position tracking may provide the given relative position that may be quantified in terms of a relative geographic location and a relative angle, of the given intermediate absolute position, with respect to the given location. Herein, the relative geographic location and the relative angle is described in a similar manner as the description of the geographic location and the angle of the device 200, respectively.

Optionally, when the second sensor 204 is implemented as another magnetometer, the relative angle of the device 200 may be measured using samples from the another magnetometer by comparing the angle of the device 200 at the given intermediate absolute position to that of the earth's magnetic field at current position thereof, with respect to the given location. When the second sensor 204 is implemented as another gyroscope, a relative angular velocity of the device 200 may be measured when the device travels between the first location and the second location. Herein, the other gyroscope may give high-resolution data rapidly when the relative angle changes with time (i.e., the relative angular velocity). As the device 200 travels between the first location and the second location, a plurality of relative angular velocities of the device 200 may be obtained, and said plurality of relative angular velocities are integrated to obtain the given relative position of the given intermediate absolute position of the device 200. Herein, the device 200 may maintain a record of the relative angle of the device 200 with more accuracy. The relative angle measured using the other gyroscope may be within the frame of reference that may need to be converted into the real-world frame of reference. When the second sensor 204 is implemented as the other accelerometer, the given relative position of the given intermediate absolute position is obtained by taking samples of relative acceleration of the device 200 from the other accelerometer, and further processing said samples of the relative acceleration of the device 200. The other accelerometer may measure the relative acceleration of the device 200 in the three axes, as mentioned previously. By using the real-world angle measurement calculated above, the device 200 may transform the relative acceleration measured in the frame of reference of the device 200 into the relative acceleration of the device 200 in global coordinates. In this regard, by integrating the transformed relative acceleration once, a relative velocity of the device 200 is obtained. Subsequently, by integrating the relative velocity, the given relative position of the device 200 is obtained, with respect to the given location.

Further referring to FIG. 1, at step 108, the method 100 comprises calculating an error in determining the at least one relative position of the device 200. Herein, the processor 208 is configured to calculate an error in determining the at least one relative position of the device 200. When the at least one relative position comprises more than the at least one relative position, then the error calculated is a cumulative error. In the present configuration, optionally, calculating the said error in determining the at least one relative position of the device 200 is based on one or more characteristics of the first sensor 202 and/or the second sensor 204. It may be appreciated that readings taken from a given sensor (namely, the first sensor and/or the second sensor) may have some error due to the one or more characteristics. Examples of the one or more characteristics may include, but are not limited to, a temperature, a humidity, a pressure, and an exposure to chemicals. It will be appreciated that faster the readings of the at least one relative position is determined, greater is the error. As measurements from the second sensor 204 are taken with high frequency, the second sensor 204 may contribute more to the said error as compared to the first sensor 202. Thereby, more specifically, the error in determining the at least one relative position of the device 200 is based on one or more characteristics of the second sensor 204. In general, the said error may take contributions of various error sources in determination of the relative position.

In an embodiment, the said error is based on one or more of: noise in the second sensor 204, offset of the second sensor 204, sample timing error of the second sensor 204. The noise in the second sensor 204 may arise due to a number of reasons such as, vibrations, interference of signals, seismic noise, and the like. The offset of the second sensor 204 may be an output that is measured using the second sensor 204 when actually the measurement should be zero. When determining the at least one relative position using acceleration, it may result in an inaccuracy which increases with time. With time, inaccuracy in measurement of at least one relative position may increase exponentially due to compounding of the cumulative error as the cumulative errors may provide feedback to themselves. The errors may come from a number of sources and may be categorized as follows: noise in gyroscope measurement (Ng), offset in gyroscope measurement (Og), sample timing errors from gyroscope measurement (Sg), noise in magnetometer measurement (Nm), offset in magnetometer measurement and error in local magnetic field (Om), noise in accelerometer measurement (Na), offset in accelerometer measurement (Oa), and sample timing errors from accelerometer measurement (Sa).

It may be noted that since at least one relative position is derived from the integration, all the errors, and in particular the offset in gyroscope measurement (Og), may build up with time from the given intermediate absolute position. The present disclosure may take contributions from sources of error from the amplitude of the feedback. A size of each of the offset contributions, such as the offset in gyroscope measurement (Og), may change slowly with the one or more characteristics of the given sensor, as mentioned above. However, the size of the sample timing error of the second sensor 204 may be dependent on a total rate of change of measured signal. From these contributions, the device 200 may determine the error. For the device at rest or under constant motion, a build-up of the error at rest is lower than that of a build-up of the error when the device is under constant motion. In the present disclosure, a rate of measurement of at least one intermediate absolute position is altered to maintain a desired accuracy of position.

The cumulative error in angle (E_{angle}) is calculated according to equation (1), as below:

$${E}_{angle} = a \times Ng \times {t}^{- 1} + b \times Og \times t + c \times Sg + d \times Nm + e \times O m \qquad ( 1 )$$

wherein, ‘t’ is the time period of determination of absolute positions, and a, b, c, d, and e are constants that depend on gain parameters of the control loop of the device 200.

The cumulative error in position (Eₚₒₛᵢₜᵢₒₙ) is calculated according to equation (2), as below:

$${E}_{position} = k \times {E}_{anlge} \times t + Na \times {t}^{- 2} + m \times Oa \times {t}^{2} + n \times Sa \times t \qquad ( 2 )$$

wherein, ‘t’ is the time period of determination of absolute positions, and k, l, m and n are constants that depend on the gain parameters of the control loop of the device 200. The time period and hence, the rate of measurement of absolute positions may be modified in order to maintain an acceptable Eₚₒₛᵢₜᵢₒₙ:

A total cumulative error (in position) is calculated according to equation (3), as below:

$${E}_{total} = \frac{1}{( \frac{1}{{E}_{forward}} + \frac{1}{{E}_{backward}} )} \qquad ( 3 )$$

wherein, ‘Eₜₒₜₐₗ’ is the total cumulative error (in position), ‘E_{forward}’ is a cumulative error (in position) when the given relative position of the given intermediate position is determined by the forward tracking of the given intermediate absolute position, and ‘E_{backward}’ is the cumulative error (in position) when the given relative position of the given intermediate position is determined by the backward tracking of the given intermediate absolute position. It may be noted that the total cumulative error is based on the error in determining the at least one relative position of the device 200.

It may be noted that, in some embodiments, a use of other combinations of the second sensor 204 may result in different calculations of the said error with time. But, principles of operation as described above hold for such embodiments. By not recording gyroscope or magnetometer information, the at least one relative position may be interpreted from interpolating measurements of the at least one intermediate absolute position, resulting in larger errors with time. However, with any combination of the second sensor 204, more information of the at least one relative position may be available than with the information of the at least one intermediate absolute position alone. Moreover, in some embodiments, other lower accuracy sources for determining the at least one intermediate absolute position may be incorporated or may replace the use of the global navigation satellite system (GNSS). In such embodiments, it may be important to account for the errors incurred in the determination of the at least one intermediate absolute position if there are varying qualities of the at least one intermediate absolute position.

Again, referring to FIG. 1, at step 110, the method 100 comprises obtaining a second absolute position of the device 200 at the second location when the error in determining the at least one relative position of the device 200 exceeds a predefined threshold. Herein, the processor 208 is configured to activate the first sensor 202 to obtain the second absolute position of the device 200 at the second location when the error in determining the at least one relative position of the device exceeds the predefined threshold. In the present implementation, the first sensor 202 is used to determine the second absolute position of the device 200. In such a case, the processor 208 may determine the path traveled by the device 200 between the first location and the second location, using, at least in part, the determined first and second absolute positions of the device 200.

As used herein, the predefined threshold may be a maximum permissible error in determination of the at least one relative position of the device 200. That is, the predefined threshold may be the maximum error allowed in determination of the at least one relative position of the device 200. In the present implementation, the processor 208 may be configured to compare the calculated error to the predefined threshold. Further, if the calculated error is above (exceeds) the predefined threshold, the processor 208 may activate the first sensor 202 to determine the second absolute position of the device 200 at the second location (as the second absolute position determined by the first sensor 202 would be accurate).

In the present embodiment, optionally, the method 100 further comprises postponing activation of the first sensor 202 for determining the second absolute position if the calculated error is within the predefined threshold. That is, the processor 208 may postpone activation of the first sensor 202 for determining the second absolute position if the calculated error is within the predefined threshold. In other words, if the calculated error is less than the predefined threshold for the second location, the processor 208 may continue using the determined relative positions for positional tracking instead of determining the second absolute position. This way the device 200 may avoid using the first sensor 202 in determination of the second location and continue using the second sensor 204 for the said purpose as much as possible. And since the second sensor 204 consumes relatively less power as compared to the first sensor 202, thus, by postponing activation of the first sensor 202, the power consumed by the device 200 may be reduced.

Optionally, the method 100 further comprises storing a record of the values of the first absolute position and the second absolute position of the device 200 determined using the first sensor 202; and/or the values of the at least one relative position of the device 200, determined using the second sensor 204. Optionally, the method 100 further comprises storing a record of the values of the at least one intermediate absolute position of the device that is received while the device is traveling between the first location and the second location. Herein, the record of the determined values of the given absolute position of the device 200 from the first sensor 202 and the determined values of the given relative position of the device 200 from the second sensor 204 may be transmitted by means of communication and may be stored in a memory. Herein, the memory may be storage devices such as, hard drive disks (HDDs), compact discs (CDs), DVD and Blu-ray discs, USB flash drives, solid-state drives (SSDs), and the like. The storing of the values of the given absolute positions, the given relative position, and the given intermediate absolute position in the memory may be used to view the overall path covered by the user carrying the device 200.

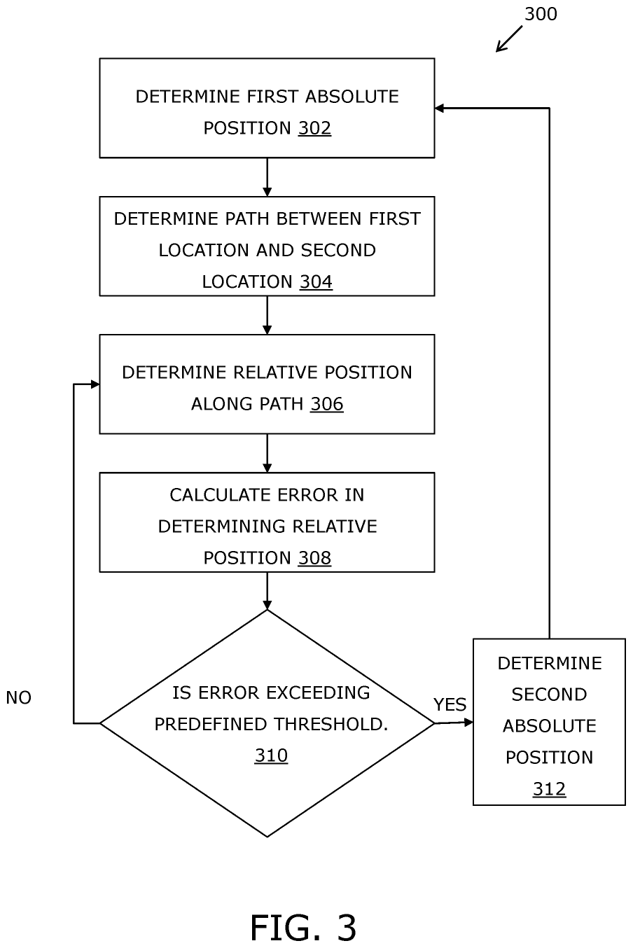

FIG. 3 is a flowchart of a process flow 300 involved in positional tracking of the device 200 of FIG. 2, in accordance with an embodiment of the present disclosure. At step 302, the first absolute position of the device 200 at a first location is obtained. At step 304, a path traveled by the device 200 between the first location and a second location is determined, based on at least one intermediate absolute position of the device that is received while the device is traveling between the first location and the second location. At step 306, the at least one relative position of the device 200 along the path between the first location and the second location is determined, wherein a given relative position of a given intermediate absolute position is determined by the forward tracking of the given intermediate absolute position with respect to the first location, and the backward tracking of the given intermediate absolute position with respect to the second location. At step 308, an error in determining the at least one relative position of the device 200 is calculated. At step 310, the calculated error is compared with a predefined threshold to determine if the error exceeds the predefined threshold. If the error is greater than the predefined threshold, at step 312, the first sensor 202 is employed to determine the second absolute position of the device 200 at the second location. If the calculated error is less than or equal to the predefined threshold, the process 300 moves back to step 306.

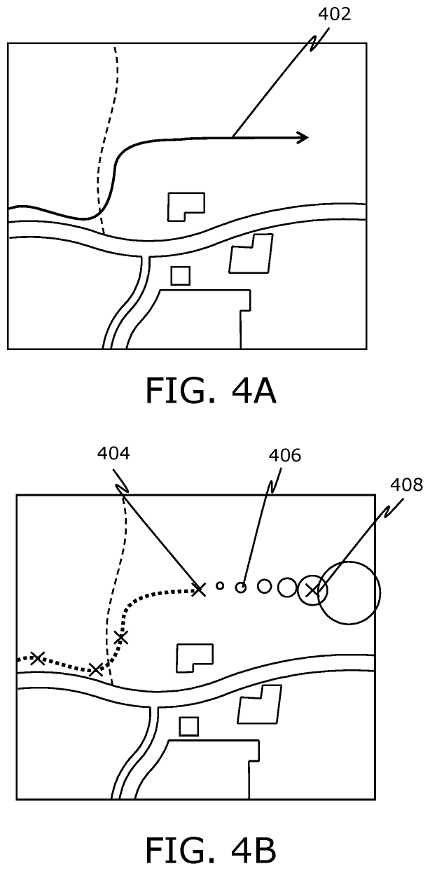

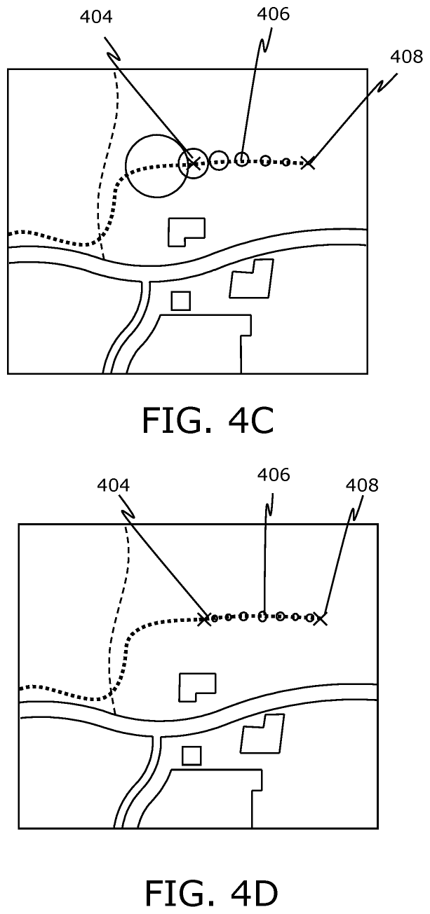

FIG. 4A is a representative illustration of a geographical area with a path 402 followed by the device 200 if the at least one intermediate absolute position is determined at regular intervals, in accordance with an embodiment of the present disclosure. Herein, the at least one intermediate absolute position is determined regularly and frequently.

Values of at least one intermediate absolute position may be recorded or transmitted to a recording device for determining the path 402. However, herein the power consumption of the device 200 may be high.

FIG. 4B is a representative illustration of the geographical area of FIG. 1 showing a contribution of error on certainty of a given relative position with time when forward tracking of a given intermediate absolute position 406 from a first location 404, in accordance with an embodiment of the present disclosure. The given intermediate absolute position 406 may be midway between the first location 404 and a second location 408. Herein, the contribution of the error on the certainty of given intermediate absolute position 406 with time when forward tracking from the first location 404 is shown by using at least one circle. Herein, a size of each circle in at least one circle is representative of an uncertainty of the given intermediate absolute position 406 of the device 200 on the path. It may be seen that the size of the circles keeps on increasing for the given intermediate absolute position 406 going forward from the first location 404 towards the second location 408. At some stage, the error of the given intermediate absolute position 406 towards the second location 408 may be too high for the error to be within the predefined threshold. In such an instance, the second absolute position at the second location 408 of the device 200 may need to be determined.

FIG. 4C is a representative illustration of the geographical area of FIG. 1 showing a contribution of the error on certainty of a given relative position with time when backward tracking of a given intermediate absolute position 406 from the second location 408, in accordance with an embodiment of the present disclosure. Herein, the contribution of the error on the certainty of the given intermediate absolute position 406 with time when backward tracking from the second location 408 is shown by using at least one circle. It may be seen that the size of each of the circles in at least one circle keeps on increasing for the given intermediate absolute position 406 going backwards from the second location 408. It may be noted that this is only possible for devices such as the device 200 of the present disclosure that may not require instantaneous real-time knowledge of position. Also, the size of each circle in at least one circle for this calculation may not depend on where the second location 408 is located.

FIG. 4D is a representative illustration of the geographical area of FIG. 1 showing a contribution of the error on certainty of a given relative position with time when both forward tracking of the given intermediate absolute position 406 from the first location 404 and backward tracking of the given intermediate absolute position 406 from the second location 408, in accordance with an embodiment of the present disclosure. Herein, the contribution of the error on the certainty of given intermediate absolute position 406 with time when forward tracking from the first location 404 and backward tracking from the second location 408 is shown by using at least one circle. Referring to FIGS. 4A-4D, it may be noted that the accuracy is achieved by taking into account a yet to be made measurement which is the second location 408, and it may be better than the accuracy that may be achieved by measuring the given intermediate absolute position twice as fast but only taking the first absolute position at the first location 404 into consideration when calculating the given relative position in the path. Herein, rather than calculating position uncertainty of every given intermediate absolute position between the first location 404 and the second location 408, a good approximation of worst-case position uncertainty is obtained by calculating the position uncertainty for the given absolute intermediate position which is generally half-way between the first location and the second location.

Thus, in order to keep the same level of accuracy, the method 100 and the device 200 of the present disclosure may need to measure at least one intermediate absolute position less than half as frequently. Further, by keeping track of the contribution to uncertainty of the at least one relative position, with time, a decision may be made about whether the determination of the at least one intermediate absolute position is needed to keep the total cumulative error below the predefined threshold. Therefore, the method 100 and the device 200 of the present disclosure may dynamically adjust to maintain the accuracy.

The method 100 and the device 200 of the present disclosure are an improvement over existing techniques for positional tracking because the device 200 maximizes the time period between the at least one intermediate absolute position while maintaining minimum accuracy of positional information by using at least one relative position determined by the second sensor 204. This results in an improvement in power consumption over the state of the art by more than a factor of two for a given level of minimum accuracy and is achieved in two ways. The device may calculate the time period between the at least one intermediate absolute position based on the error, using a longest time period that can achieve the minimum accuracy. Secondly, by deferring the determination of the at least one intermediate absolute position until after a next at least one intermediate absolute position, the error may be interpreted as the total error which may be combination of that measured from the at least one intermediate absolute position as well as that measured of the next at least one intermediate absolute position yet to be determined which may be at the second location. Thereby, the power consumption of the device 200 is reduced.

In one or more implementations, the device and the method of the present disclosure may be used particularly but not exclusively as an animal location tracker.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A method for positional tracking of a device, comprising:
obtaining a first absolute position of the device at a first location;
determining a path traveled by the device between the first location and a second location, based on at least one intermediate absolute position of the device that is received while the device is traveling between the first location and the second location;
determining at least one relative position of the device along the path between the first location and the second location, wherein a given relative position of a given intermediate absolute position is determined by forward tracking of the given intermediate absolute position with respect to the first location, and backward tracking of the given intermediate absolute position with respect to the second location;
calculating an error in determining the at least one relative position of the device; and
obtaining a second absolute position of the device at the second location when the error in determining the at least one relative position of the device exceeds a predefined threshold.

2. The method according to claim 1, wherein a first sensor is used to determine the first absolute position and the second absolute position of the device.

3. The method according to claim 1, wherein a second sensor is used to determine the at least one relative position of the device along the path between the first location and the second location.

4. The method according to claim 3, wherein calculating the error in determining the at least one relative position of the device along the path is based on one or more characteristics of the first sensor and/or the second sensor.

5. A method according to claim 4, comprising postponing activation of the first sensor for determining the second absolute position if the calculated error is within the predefined threshold.

6. A method according to claim 4, wherein the error is based on one or more of: noise in the second sensor, offset of the second sensor, sample timing error of the second sensor.

7. A method according to claim 1 further comprising storing a record of the values of the first absolute position and the second absolute position of the device, determined using the first sensor; and/or the values of the at least one relative position of the device, determined using the second sensor.

8. A device for positional tracking, comprising:
a first sensor configured to determine a first absolute position of the device at a first location, when activated;
a second sensor configured to determine at least one relative position of the device between the first location and a second location;
a battery for supplying power to at least the first sensor;
a processor configured to:
receive information about the first absolute position of the device as determined by the first sensor;
determine a path traveled by the device between the first location and the second location, based on at least one intermediate absolute position of the device that is received while the device is traveling between the first location and the second location;
receive information about the at least one relative position of the device along the path between the first location and the second location as determined by the second sensor, wherein a given relative position of a given intermediate absolute position is determined by forward tracking of the given intermediate absolute position with respect to the first location, and backward tracking of the given intermediate absolute position with respect to the second location;
calculate an error in determining the at least one relative position of the device; and
activate the first sensor to obtain a second absolute position of the device at the second location when the error in determining the at least one relative position of the device exceeds a predefined threshold.

9. The device according to claim 8, wherein the processor is configured to calculate the error in determining the at least one relative position of the device along the path, based on one or more characteristics of at least one of the first sensor and the second sensor.

10. A device according to claim 9, wherein the processor is further configured to postpone activation of the first sensor for determining the second absolute position if the calculated error is within the predefined threshold.

11. A device according to claim 9, wherein the error is based on one or more of: noise in the second sensor, offset of the second sensor, sample timing error of the second sensor.

12. A device according to claim 8 comprising a memory configured to store a record of the values of first absolute position and the second absolute position of the device, determined using the first sensor; and the values of the at least one relative position of the device, determined using the second sensor therein.
